(19) United States
(12) Patent Application Publication
(10) Pub. No.: US 2023/0362000 A1
(43) Pub. Date: Nov. 9, 2023

(54) SMART WEARABLE OR SMART GARMENT TAGS AND RELATED ENGAGEMENT PLATFORMS

(71) Applicant: Prosilion Inc., New York, NY (US)

(72) Inventor: George Monemvasitis, Beverly Hills, CA (US)

(73) Assignee: Prosilion Inc., New York, NY (US)

(21) Appl. No.: 18/351,514

(22) Filed: Jul. 13, 2023

Related U.S. Application Data
(63) Continuation-in-part of application No. 17/432,431, filed on Aug. 19, 2021.
(60) Provisional application No. 63/368,300, filed on Jul. 13, 2022.

(30) Foreign Application Priority Data
Aug. 14, 2019 (AU) 2019902933

(51) Int. Cl. H04L 9/08; G06F 1/16; G06K 19/077

(52) U.S. Cl. CPC H04L 9/088; G06F 1/163; G06K 19/07762

(57) ABSTRACT

A system includes a smart wearable having a unique tag identifier, an interface receiving a user interaction information, the interface facilitates interactions with one or more users. The interface may execute a two-factor authentication comprising a user account identification, as a first factor of the two-factor authentication, wherein the user account is associated with a unique fan identifier; and a shared key identification, as a second factor of the two-factor authentication, wherein the shared key is defined by the interface using an Application Processing Interface (API) payload based on the unique tag identifier. The interface may associate the unique tag identifier to the unique fan identifier to authenticate the smart wearable.

### FIELD OF THE DISCLOSURE

The embodiments discussed in the present disclosure are generally related to management of smart wearables and related engagement platforms and, more particularly, relate to an interface that facilitates interactions with users associated with the smart wearables. The invention further relates to an analytics of fan engagement through associated authentic smart wearables.

### BACKGROUND OF THE DISCLOSURE

Conventionally, producers and merchants mark their products with hang-tag labels with bar codes for product scanning at the point of sale along with logos, brand names, sizes, colors, and pricing information. Numerous hangtags are commercially accessible. To date, labels and hand tags may have been effective in their usages concerning wearables, such as garments management and keeping the inventory in any facilities.

However, with increasing consumerism, these facilities are now receiving products in many large numbers and, more often than not, it has become difficult for the facility managers to manage the inventory.

Further, traditional systems and methods take too long to recognize the actual clothing article, which impacts the marketing environment.

Accordingly, there exists a need for a smart wearable and related engagement platform to facilitate easy maintenance of interfaces and platforms that allow users to track and facilitate interactions using smart wearables. There is also a need for an analytics of fan engagement using associated authentic smart wearables.

### SUMMARY OF THE DISCLOSURE

The following represents a summary of some embodiments of the present disclosure to provide a basic understanding of various aspects of the disclosed herein. This summary is not an extensive overview of the present disclosure. It is not intended to identify essential or critical elements of the present disclosure or to delineate the scope of the present disclosure. Its sole purpose is to present some embodiments of the present disclosure in a simplified form as a prelude to the more detailed description that is presented below.

The subject matter of the present disclosure may include a system for managing smart wearables in a computing environment. The system includes an intelligent wearable having a unique tag identifier, and an interface receiving a user interaction information, and the interface facilitates interactions with one or more users. The interface executes a two-factor authentication comprising a user account identification, as the first factor of the two-factor authentication, wherein the user account is associated with a unique fan identifier, and a shared key identification, as a second factor of the two-factor authentication, wherein the shared key is defined by the interface using an Application Processing Interface (API) payload based on the unique tag identifier. The interface further associates the unique tag identifier to the unique fan identifier to authenticate the smart wearable.

In an embodiment of the present disclosure, the system further includes an identification tag associated with the unique tag identifier, wherein the identification tag is defined by the interface using the API payload. The identification tag is embedded in the smart wearable.

In an embodiment of the present disclosure, the system further includes an authentication module for updating and/or re-validating ownership of the smart wearable at each interaction of the user with the interface. The authentication module updates the ownership of the smart wearable from a first user with a first unique fan identifier to a second user with a second unique fan identifier based on the API payload corresponding to an interaction of the second user with the interface.

In an embodiment of the present disclosure, the system further includes an engagement module for sending a push notification regarding a campaign associated with the smart wearable to the user account and capturing an interaction of the user with the push notification as fan engagement data associated with the user account. The engagement module defines a response time window associated with the campaign such that the response time window defines a time period when the interface accepts the interaction with the push notification. Further, The engagement module sends the push notification to one or more user accounts based on geolocation data associated with the one or more user accounts.

In an embodiment of the present disclosure, the system further includes a headless analytics and activation platform for analyzing interactions of the one or more users with the interface to generate fan engagement data for associated smart wearables.

The subject matter of the present disclosure discloses a method for managing smart wearables in a computing environment. The method includes receiving a unique tag identifier associated with a smart wearable, and receiving user interaction information by an interface facilitating interactions with one or more users, wherein the interface is configured to execute a two-factor authentication comprising: executing a first factor of the two-factor authentication based on a user account identification, wherein the user account is associated with a unique fan identifier, executing a second factor of the two-factor authentication based on a shared key, wherein the shared key is defined by the interface using an Application Processing Interface (API) payload based on the unique tag identifier, and associating the unique tag identifier to the unique fan identifier to authenticate the smart wearable.

In an embodiment of the present disclosure, the method further includes receiving the unique tag identifier associated with an identification tag, wherein the identification tag is defined by the interface using the API payload. The identification tag is embedded in the smart wearable.

In an embodiment of the present disclosure, the method further includes updating or re-validating ownership of the smart wearable at each interaction of the user with the interface. The method includes updating the ownership of the smart wearable from a first user with a first unique fan identifier to a second user with a second unique fan identifier based on the API payload corresponding to an interaction of the second user with the interface.

In an embodiment of the present disclosure, the method further includes sending a push notification regarding a campaign associated with the smart wearable to the user account and capturing an interaction of the user with the push notification as fan engagement data associated with the user account.

In an embodiment of the present disclosure, the method further includes defining a response time window associated with the campaign such that the response time window defines a time period when the interface accepts the interaction with the push notification.

In an embodiment of the present disclosure, the method further includes sending the push notification to one or more user accounts based on a geolocation data associated with the one or more user accounts.

In an embodiment of the present disclosure, the method further includes analyzing interactions of the one or more users with the interface to generate fan engagement data for associated smart wearables.

The subject matter of the present disclosure may relate to non-transitory computer-readable storage medium, having stored thereon a computer-executable program which, when executed by at least one processor, causes the at least one processor to analyze a unique tag identifier associated with a smart wearable, and analyze a user interaction information received from an interface facilitating interactions with one or more users, wherein the interface is configured to execute a two-factor authentication comprising: executing a first factor of the two-factor authentication based on a user account identification, wherein the user account is associated with a unique fan identifier, executing a second factor of the two-factor authentication based on a shared key, wherein the shared key is defined by the interface using an Application Processing Interface (API) payload based on the unique tag identifier, and associating the unique tag identifier to the unique fan identifier to authenticate the smart wearable.

In an embodiment of the present disclosure, the computer-executable program further causes the at least one processor to update and/or re-validate an ownership of the smart wearable at each interaction of the user with the interface.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF DRAWINGS

Further advantages of the disclosure will become apparent by reference to the detailed description of preferred embodiments when considered in conjunction with the drawings. In the drawings, identical numbers refer to the same or a similar element.

FIG. 1 illustrates an example network architecture for smart wearable management.

FIG. 2 is a schematic diagram illustrating an example system for tracking and facilitating interaction with users associated with smart wearables.

FIG. 3 illustrates a process flow for creating a club and adding users in a system.

FIG. 4 illustrates a process flow for adding smart wearables in a system.

FIGS. 5A-5C illustrate a process flow for a two-factor authentication set-up.

FIGS. 6A-6B illustrate a process flow for creating campaigns.

FIG. 7 illustrates a sequential flow diagram for managing smart wearables.

The headings used herein are for organizational purposes only and are not meant to be used to limit the scope of the description. As used throughout this application, the word “may” be used in a permissive sense (i.e., meaning having the potential to) rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines unless the usage context indicates otherwise.

### DETAILED DESCRIPTION

The following detailed description is presented to enable a person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown but is to be accorded the broadest possible scope consistent with the principles and features disclosed herein.

Certain terms and phrases have been used throughout the disclosure and will have the following meanings in the context of the ongoing disclosure.

A “network” may refer to a series of interconnected nodes or network elements via communication paths. In an example, the network may include any number of software and/or hardware elements coupled to each other to establish the communication paths and route data/traffic via the established communication paths. The network may include but is not limited to, the Internet, a local area network (LAN), a wide area network (WAN), an Internet of things (IoT) network, and/or a wireless network. Further, The network may comprise, but is not limited to, copper transmission cables, optical transmission fibers, wireless transmission, routers, firewalls, switches, gateway computers, and/or edge servers.

A “device” may refer to an apparatus using electrical, mechanical, thermal, etc., power and having several parts, each with a definite function and together performing a particular task. A device may include but is not limited to, a user device, a server device, and/or a combination of the two. The device may be equipped for two-factor authentication and the device may further comprise a reader capable of detecting identification tags.

A “processor” may include a module that performs the methods described. The module of the processor may be programmed into the integrated circuits of the processor, or loaded in memory, storage device, or network, or combinations thereof.

The term “database”, as used herein, may refer to an organized collection of structured information, or data, typically stored electronically in a computer system. The term “database” may be used interchangeably with the word “library” and/or “repository” without departing from the scope of the disclosure.

A system for managing smart wearables in a computing environment. The system includes a smart wearable with a unique tag identifier, such as a garment. The system further includes an interface, such as a club portal, for receiving a user interaction information. The interface and/or the club portal facilitates interactions with one or more users. The interface further executes a two-factor authentication comprising a user account identification, as a first factor of the two-factor authentication, wherein the user account is associated with a unique fan identifier and a shared key identification, as a second factor of the two-factor authentication, wherein the shared key is defined by the interface using an Application Processing Interface (API) payload based on the unique tag identifier. The interface further associates the unique tag identifier to the unique fan identifier to authenticate the smart wearable.

A two-factor authentication method for an identification tag and related engagement platforms or system is provided to facilitate easy maintenance of headless analytics and activation platform that allows clubs to track and facilitate interactions via the use of identification tags associated with smart wearables.

In some embodiments, headless analytics and activation platforms or system is provided that performs analytics of fan engagement using smart wearable tag data.

More specifically, in various embodiments, the present system may allow clubs to associate a unique tag identifier with a unique fan identifier using API payload. This association will allow smart wearable details from a database to be tied to a unique fan identifier. Further, through an interface or a club portal, a push notification associated with a campaign may be sent to one or more users that may require an interaction with the interface, such as, a tap to receive a response. In some embodiments, the present system may allow viewing and analyzing anonymized fan data. Further, a club may send a campaign to a fan in a specific geolocation. A club may send a campaign that is time-specific. A club may send a tap limited campaign (for example, the first 100 taps count). Further, through the interface and/or the club portal, a club may track and see user's interactions, such as taps, per campaign. A club may send a push notification based on a smart wearable, such as, a garment, which may not require any interaction and/or tap to receive. In some embodiments, the present system may provide a method and platform for authenticating that a smart wearable is genuine.

In one or various embodiments, such a system may, for enabling the operation thereof, include a network device, a device, a database, and a club portal. The system may also include a computer-driven network with a communications component. Identification tags, such as, near-field communication (NFC) based tags or radio-frequency identification (RFID) tags defined by a club using an API payload, may be the system's unique tag identifier. The identification tag may be used in one implementation of the invention to collect data on the smart wearable. Further, an identification tag reader may comprise processing components coupled to a code reader. A smart wearable may also include a NFC tag.

The NFC tag could be a code integrated into the smart wearable to gather data. According to embodiments of the present invention, the system may comprise processing components that may include a Programmable Logic Control unit (PLC), a microcontroller, a microprocessor, a computing device, a development board, and so forth. Embodiments of the present invention are intended to include or otherwise cover any processing components including known, related art, and/or later developed technologies that may be capable of processing the received data.

Further, the present system may also preclude various conventional requirements that were earlier needed to establish a club platform. There may not be a need for a user and/or a fan to set up a specific account. To remove barriers to sign up, the interface and/or the club portal will be able to send user account details and/or unique fan identifiers using the API payload, removing the need for a system identifier.

To ensure data privacy, the present solution might not allow the club portal to collect fan-specific details. The system may only collect and store the data that it needs to play its role. In the proposed solution, the onus may be on the club to have a meaningful identifier, such as, a membership number, against a user or a fan to leverage their interaction data with the proposed system. The club portal may view and report on aggregate and anonymized data. For example, the fan engagement data may suggest that 425 people with the 2021 Home jersey tapped on the “September 4th Away Day Campaign” campaign. The system may protect data privacy of individual fans and avoid data reporting; such as, John Smith, who is 24 years old, who lives in London, tapped on the campaign called “September 4th Away Day Campaign”.

The present solution may provide ownership authentication methods and may not need the clubs to lock ownership or conduct theft protection. In some embodiments, the ability to have the smart wearable in a fan's possession outweighs any rigorous theft protection at Point of Sale (POS) terminals. Ownership may be determined on a last tap wins system, with each tap re-validating the owner against the smart wearable. For example, whether it's the fan's first tap when they buy a garment, or their 200th tap after participating in many campaigns, the same payload will be sent to a centralized database to tie the unique fan identifier to the unique tag identifier.

These and other advantages will be apparent from applying the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible by using, alone or in combination, one or more of the features set forth above or described in detail below.

In any embodiment described herein, the open-ended terms “comprising” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of, the like.

As used herein, the singular forms “a”, “an,” and “the” designate both the singular and the plural, unless expressly stated to designate the singular only.

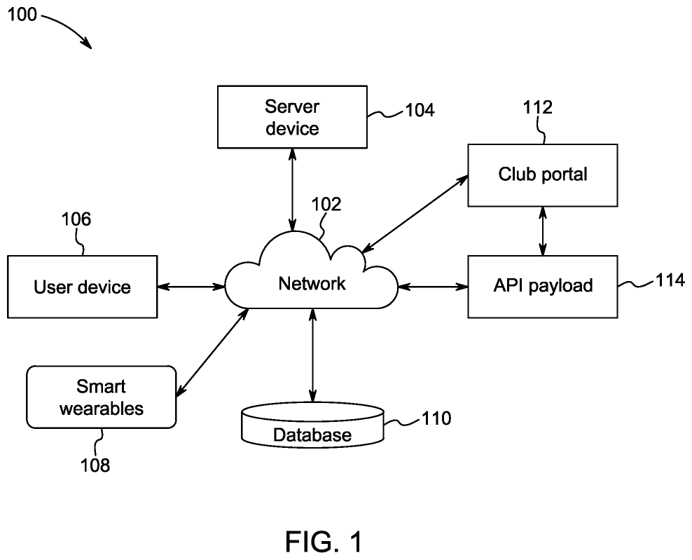

The embodiments of the methods and systems are described in more detail with reference to FIGS. 1-7.

FIG. 1 illustrates an example network architecture 100 for innovative wearable management with which various embodiments of the present disclosure may be implemented. FIG. 1 is shown in simplified, schematic format for purposes of illustrating a clear example, and other embodiments may include more, fewer, or different elements. FIG. 1 and the other drawing figures, and all of the description and claims in this disclosure are intended to present, disclose and claim a technical system and technical methods. The technical system and methods as disclosed includes specially programmed computers, using a special-purpose distributed computer system design and instructions programmed to execute the described functions. These elements execute to provide a practical application of computing technology to manage smart wearables and authenticate smart wearables. In this manner, the current disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

The network architecture 100 for management of smart wearables and associated data in a computing environment is shown in FIG. 1. As shown, the network architecture 100 includes server device 104, user device 106, and smart wearables 108, all communicating with a network 102. The ecosystem includes one or more a database 110 in communication with the network 102. The computing environment 100 further includes an interface, such as a club portal 112 and API payload 114 in communication with the network 102. Furthermore, the network 102 may be a communication network configured to implement different networking technologies, such as, fixed (Ethernet, fiber, xDSL, DOCSIS®, USB, etc.), mobile WAN (2G, 3G, 4G, 5G, etc.), Wireless LAN (WiFi®, etc.), and Wireless PAN (Bluetooth®, WiGig, ZWave®, ZigBee®, IrDA, etc.). The network architecture 100 may implement a server-client architecture. In an embodiment, network 102 may correspond to a medium through which content and messages flow between various devices of the network architecture 100, e.g., the server device 104, user device 106, smart wearables 108, database 110, club portal 112, and API payload 114. Various devices in the network architecture 100 can connect to network 102 in accordance with the various wired and wireless communication protocols such as Transmission Control Protocol and Internet Protocol (TCP/IP), User Datagram Protocol (UDP), and 2G, 3G, 4G or 5G communication protocols.

The network architecture 100 may represent an ecosystem for smart wearable authentication and management A user and/or a fan may interact with the user device 106 and/or the club portal 112 in the network architecture 100 for providing inputs and consuming output from these devices.

The server device 104 may include one or more computer programs or sequences of computer-executable instructions. Computer executable instructions described herein may be in machine-executable code in the instruction set of a CPU and may be compiled based upon source code written in Python, JAVA, C, C++, OBJECTIVE-C, or any other human-readable programming language or environment, alone or in combination with scripts in JAVASCRIPT, other scripting languages and other programming source text. In another embodiment, the programmed instructions may also represent one or more files or projects of source code that are digitally stored in a mass storage device, such as non-volatile RAM or disk storage, in the systems of FIG. 1 or a separate repository system, which when compiled or interpreted cause generation of executable instructions that in turn upon execution cause the computer to perform the functions or operations that are described herein with reference to those instructions. In other words, the figure may represent how programmers or software developers organize and arrange source code for later compilation into an executable, or interpretation into bytecode or the equivalent for execution by the server device 104.

The user device 106 may include a mobile device, a smart phone, a tablet computer, a portable computer, a laptop computer, a desktop computer, a smart device, a smart watch, a smart glass, or any other type of computing device that allows access to the server device 104.

Smart wearables 108 may include any garment, accessory, or other item worn on the human body, such as clothing, hats, shoes, socks, belts, wrist and/or ankle bands, etc. Smart wearables 108 may have one or more sensors, processing, and/or communication modules embedded or associated with them. For example, the smart wearable 108 may include a garment with an embedded near-field communication (NFC) tag. In some embodiments, the smart wearables 108 may communicate with one or more other devices or components of the network architecture 100 through network 102.

Further, the server device 104, user device 106, and smart wearables 108 may be communicatively coupled to the database 110. In some embodiments, the database 110 may store data associated with smart wearables, such as wearable ID, images, specifications, and the like. The database 110 may also store data associated with one or more clubs and interaction data gathered from club portal 112. Database 110 may include additional databases and/or repositories storing data that may be used by the server device 104. Each database may be implemented using memory, e.g., RAM, EEPROM, flash memory, hard disk drives, optical disc drives, solid state memory, or any type of memory suitable for database storage.

The network architecture 100 may further include club portal 112 and API payload 114 which will be described in detail concerning subsequent figures.

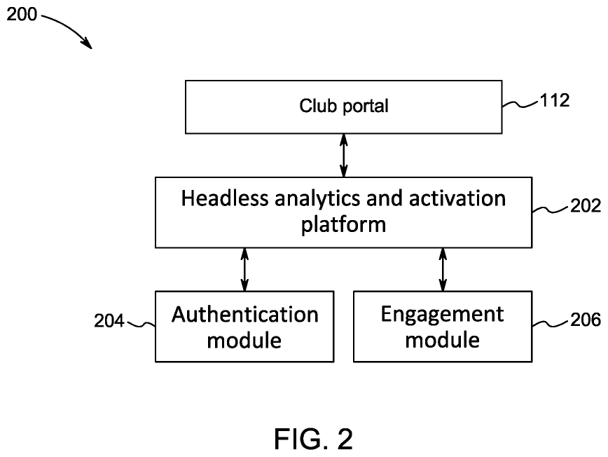

FIG. 2 is a schematic diagram illustrating an example system 200 for tracking and facilitating interaction with users associated with smart wearables. FIG. 2 shows that system 200 includes club portal 112, headless analytics and activation platform 202, authentication module 204, and engagement module 206. The club portal 112 may refer to an interface, such as a user interface, for facilitating interaction between one or more users or fans or club members and the club portal 112. The club portal 112 may interact with the server device 104, the user device 106, smart wearables 108, and the database 110 through network 102. The club portal 112 acts as an interface between clubs and club members associated with smart wearables. The club portal 112 may interact with one or more devices at the server or with the user through API.

Further, as shown in FIG. 2, system 200 includes a headless analytics and activation platform 202. The headless analytics and activation platform 202 may include analytical architecture that decouples the analytical backend from the presentation layer. The headless analytics and activation platform 202 may include compute, storage, and network resource arrangements, as required for executing associated function(s). In some embodiments, the headless analytics and activation platform 202 may be implemented using standards-based data protocols, APIs, and SDKs. Further, the headless analytics and activation platform 202 may support different deployment options such as fully hosted service, cloud-native deployments, etc. The headless analytics and activation platform 202 may be configured to analyze interactions of the one or more users and/or fans with the interface or the club portal 112 to generate fan engagement data for associated smart wearables.

The system 200 further includes an authentication module 204. The authentication module 204 may be implemented as a module that performs the methods described. The authentication module 204 may be programmed into the integrated circuits of a processor or loaded in memory, storage device, or network, or combinations thereof. The authentication module 204 may also be implemented as a hardware module or a combination of both hardware and software modules without limitation. The authentication module 204 may update and/or re-validate an ownership of the smart wearable at each interaction of the user with the club portal 112. Further, in some embodiments, the authentication module 204 may update the ownership of the smart wearable from a first user with a first unique fan identifier to a second user with a second unique fan identifier based on an API payload corresponding to an interaction of the second user with the club portal 204.

The system 200 further includes an engagement module 206. The engagement module 206 may be implemented as a module that performs the methods described. The engagement module 206 may be programmed into the integrated circuits of a processor or loaded in memory, storage device, or network, or combinations thereof. The engagement module 206 may also be implemented as a hardware module or a combination of both hardware and software modules without limitation. The engagement module 206 may facilitate engagement between clubs and club members through the club portal 112 and gather fan engagement data for further analysis by other systems, such as, the headless analytics and activation platform 202. The engagement module 206 sends, via the club portal 112, a push notification regarding a campaign associated with the smart wearable to a user account associated with a club member and/or a fan. The engagement module 206 further captures an interaction of the user with the push notification as fan engagement data associated with the user account. In some embodiments, the engagement module 206 may define a response time window associated with the campaign such that the response time window defines a time period when the interaction with the push notification is accepted by the club portal 112. Further, in some embodiments, the engagement module 206 may send the push notification to one or more user accounts based on a geolocation data associated with the one or more user accounts.

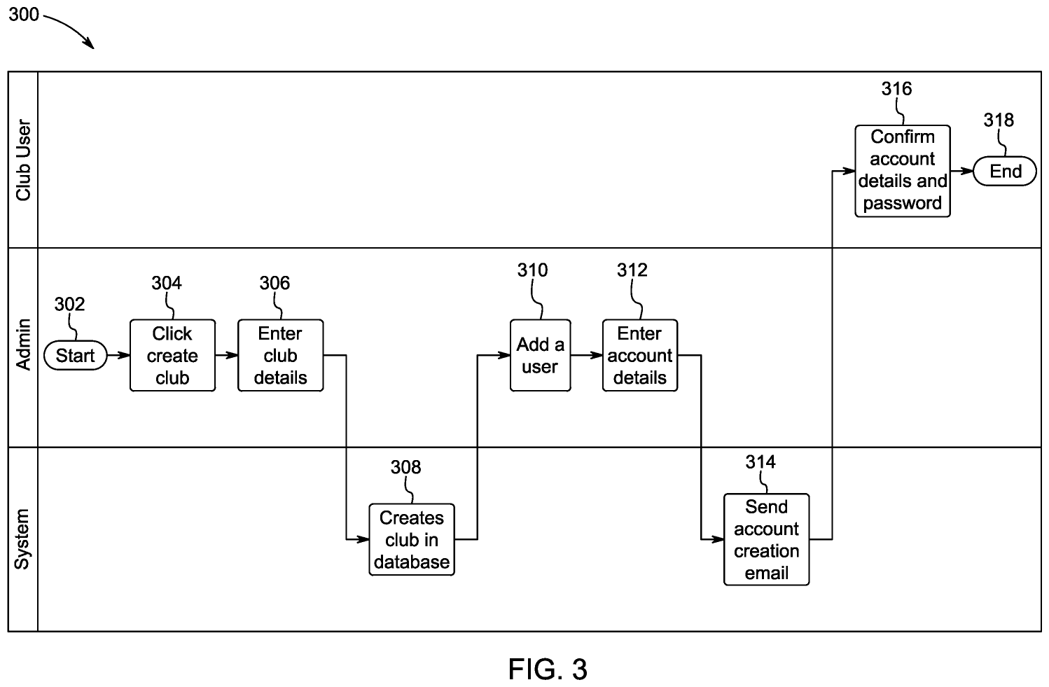

FIG. 3 illustrates a process flow 300 for creating a club and adding users in a system, according to embodiments of the present invention. The system for implementing the process flow 300 may include the club portal 112 configured on the network device, for example. Using the club portal 112, a plurality of users may be added by an admin to create the club. An admin, a club user, and others may all have access to the club portal 112. As depicted in FIG. 3, the process flow starts at step 302. At step 304, the admin can select the “Click create club” option to create the club. At step 306, the admin enters club details, such as club name, date of creation, club rules, number of members, etc. At step 308, the entered details are provided to the system, such as the server device 104, to create club in a database, such as the database 110. At step 310, the system might enable the admin to add a user to the created club. At step 312, the admin enters account information associated with the user when adding the user to the club. In an embodiment, the club they are associated with must be selected when creating a user. A club may also be chosen based on the club with which a user is associated. One implementation of the current invention allows for account creation via email, phone, or any other communication means. At step 314, the system may send an account creation email to the user. At step 316, the club user may confirm and/or provide account details and password associated with the user account. The system may check and confirm the account information and password, and the process flow may end at step 318.

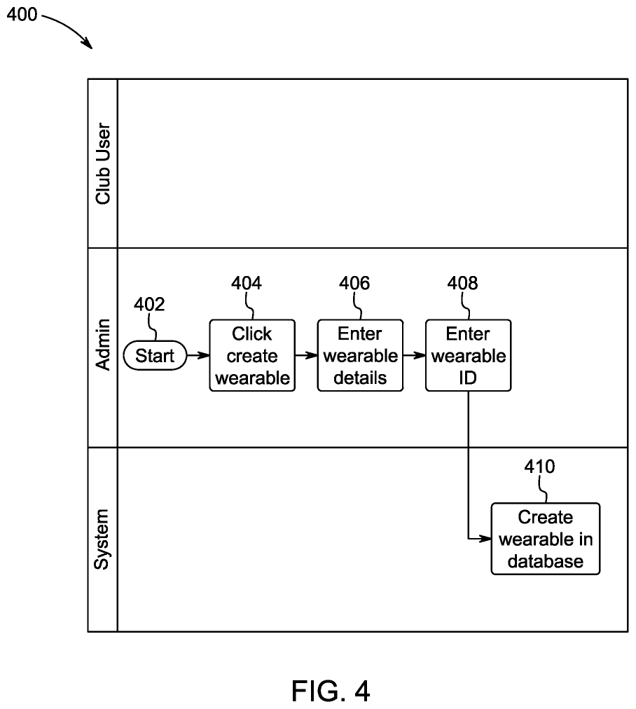

FIG. 4 illustrates a process flow 400 for creating smart wearables in a system, according to embodiments of the present invention. As depicted in FIG. 4, the process flow 400 may start at step 402. At step 404, the admin may click create wearable on the club portal 112. At step 406, the admin may add details associated with the smart wearable, such as a garment name, a garment image, and the like. Additionally, the admin may specify garment information such as color, release year, key value pairs, garment type, etc. At step 408, the admin may add a wearable ID to the system. In some embodiments, the admin may add multiple wearables to the portal and may paste a list of wearable IDs at step 408. If not duplicated, one or more wearable IDs may be created in the database 110. However, if duplicated, the system may direct to re-enter the correct wearable IDs and remove the incorrect wearable IDs. In some embodiments, the further modifications may be made to the created wearables. For example, an admin or a club user may search wearable IDs, add wearable IDs, and delete wearable IDs, thus updating the wearable entry in the database 110.

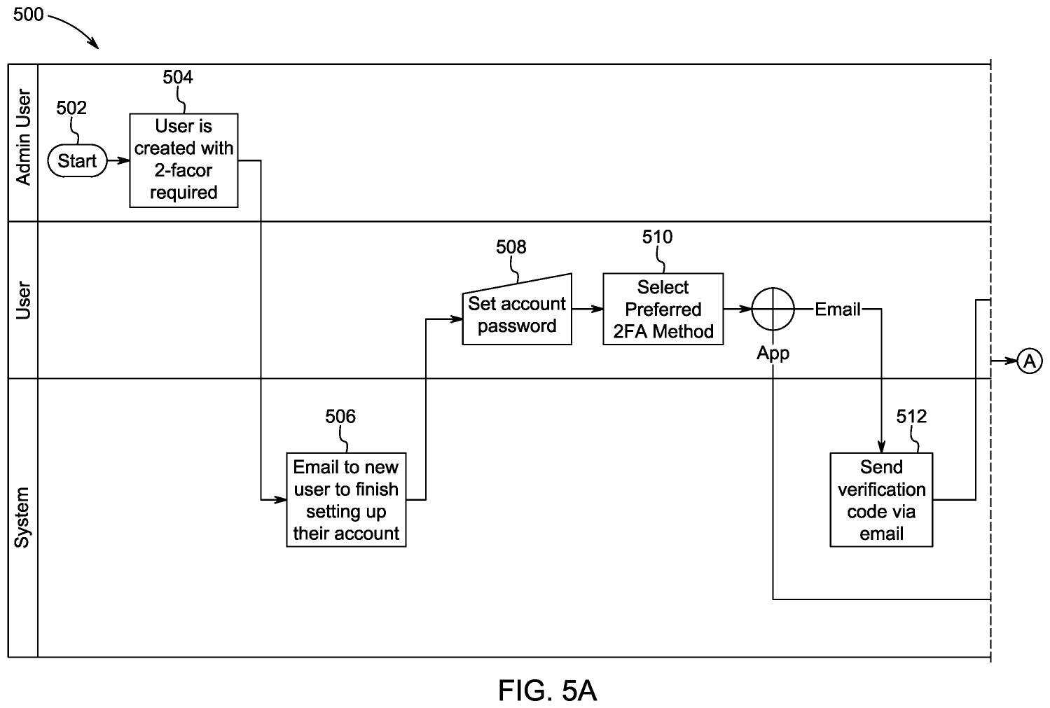

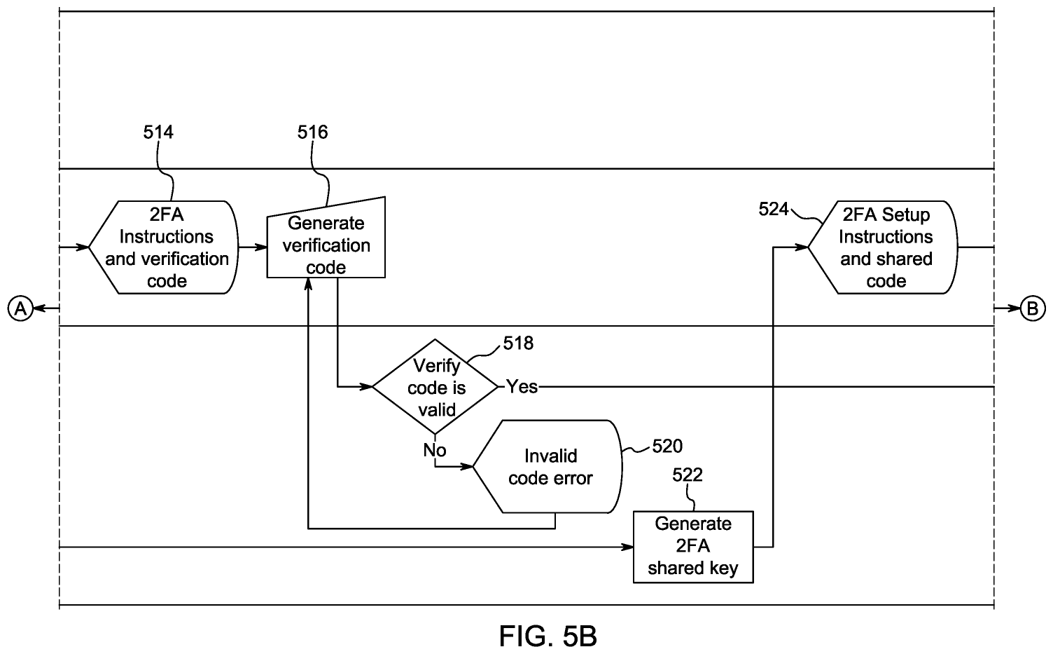

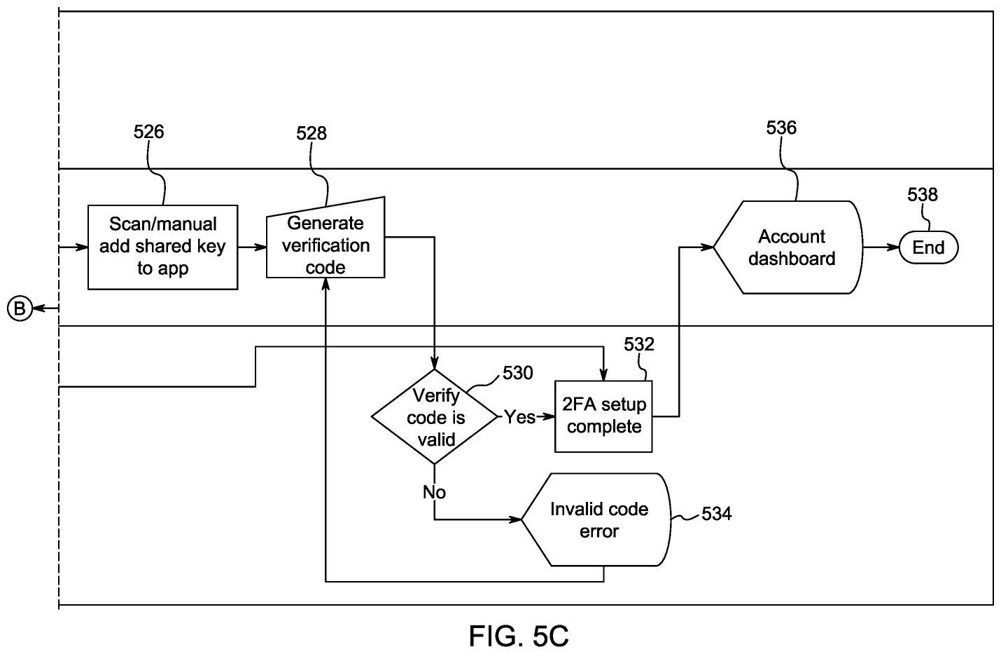

FIGS. 5A-5C illustrate a process flow 500 for a two-factor authentication set-up, according to embodiments of the present invention. As described above, the smart wearable may be associated with a unique tag identifier. An identification tag may be associated with or embedded in the smart wearable. In some embodiments, the identification tag may be a near-field communication (NFC) based tag. In some embodiments, the identification tag may be a Radio Frequency Identification (RFID) based tag. Further, a device implementing the embodiments of the present disclosure, such as, the user device 106, may comprise a reader capable of detecting the identification tag associated with the smart wearable. For example, the device may consist of a processor, a memory that stores processor-executable codes, and an NFC communication module that can wirelessly connect with one or more NFC tags. The memory-stored processor-executable codes can be used to program the processor to carry out a plurality of operations. The device may further be equipped for two-factor authentication for authenticating the smart wearable by the process flow 500.

The two-factor authentication may include a user account identification, as a first factor of the two-factor authentication. The user account, as described above, is associated with a unique fan identifier. Further, as a second factor of the two-factor authentication, the interface and/or the club portal 112 may define a shared key using an Application Processing Interface (API) payload based on the unique tag identifier. The system may verify the shared key as a shared key identification. Once both factors are authenticated, the system and/or the club portal 112 may associate the unique tag identifier to the unique fan identifier to authenticate the smart wearable. The association described above may define ownership of the smart wearable. Further, in an embodiment of the present disclosure, the system may update and/or re-validate an ownership of the smart wearable at each interaction of the user with the interface. The system updates the ownership of the smart wearable from a first user with a first unique fan identifier to a second user with a second unique fan identifier based on the API payload corresponding to an interaction of the second user with the interface. For example, the first user may transfer ownership of the smart wearable to the second user, who may then scan the smart wearable tag to associate the smart wearable with a user account or a unique fan identifier associated with the second user.

Two-factor authentication setup is discussed in detail below with reference to FIGS. 5A-5C.

As shown in FIGS. 5A-5C, the process flow 500 starts at step 502. At step 504, an admin creates a new user with two-factor authentication requirement. At step 506, the system provides a notification, such as an email, to the new user to finish setting up their user account. At step 508, the user may set a password for the user account. At step 510, the user may select a preferred two-factor authentication method. For example, a user may choose an email-based authentication to proceed with the two-factor authentication or may choose an app-based authentication. It should be noted that the present disclosure is not limited to these methods, and any suitable means or process for exchanging a shared key may be implemented.

If the user selects email-based-authentication, then at step 512, the system sends a verification code to the user via email. At step 514, the user receives two-factor authentication instructions and a verification code. At step 516, the verification code is generated for verification. If the verification code is invalid at step 518, the process flow 500 proceeds to step 520 and the user receives an invalid code error. The verification code is generated again at step 516. If the verification code is valid at step 518, the process flow 500 proceeds to step 532 and the two-factor authentication set-up is complete.

If the user selects app-based authentication, then at step 522, the system generates a shared key. At step 524, the user receives two-factor authentication instructions and shared key. At step 526, the user may scan a tag or manually add the shared key to the app associated with the club portal 112. At step 528, a verification code may be generated for verification. If the verification code is valid at step 530, the process flow 500 proceeds to step 532, and the two-factor authentication set-up is complete. If the verification code is invalid at step 530, the process flow 500 proceeds to step 534 and the user receives an invalid code error. The verification code is generated again at step 528. Further, at step 536, on successful set-up of the two-factor authentication, an account dashboard may be created for the user. The process flow 500 ends at step 538.

In some embodiments of the present disclosure, a user may modify the chosen preferred two-factor authentication method. The user may log in for two-factor authentication using a username and password credentials. When the credential is valid the two-factor authentication may be initiated via account preferred method. Further, according to some embodiments, the user may opt for password recovery if the password credentials are lost. A password reset email may be sent if the account email address matches and a new password form may be displayed on the club portal 112. A new password may be added twice, matched, and updated in the database 110.

In an embodiment of the present invention, a user may change the email address associated with the user account by accessing the account setting and updating the active email address for account in database 110.

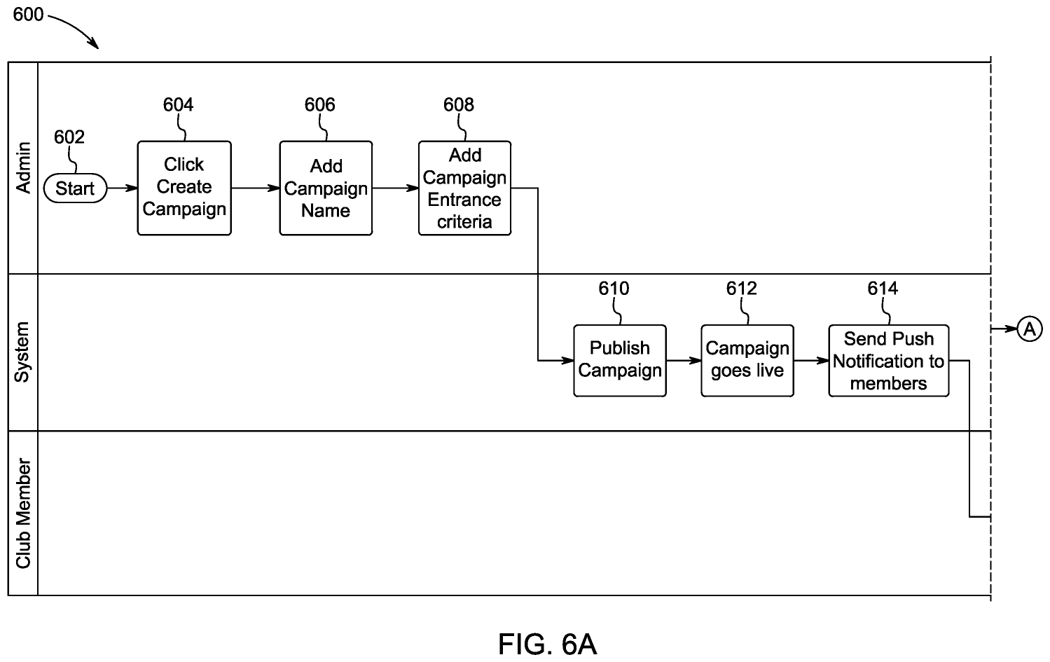

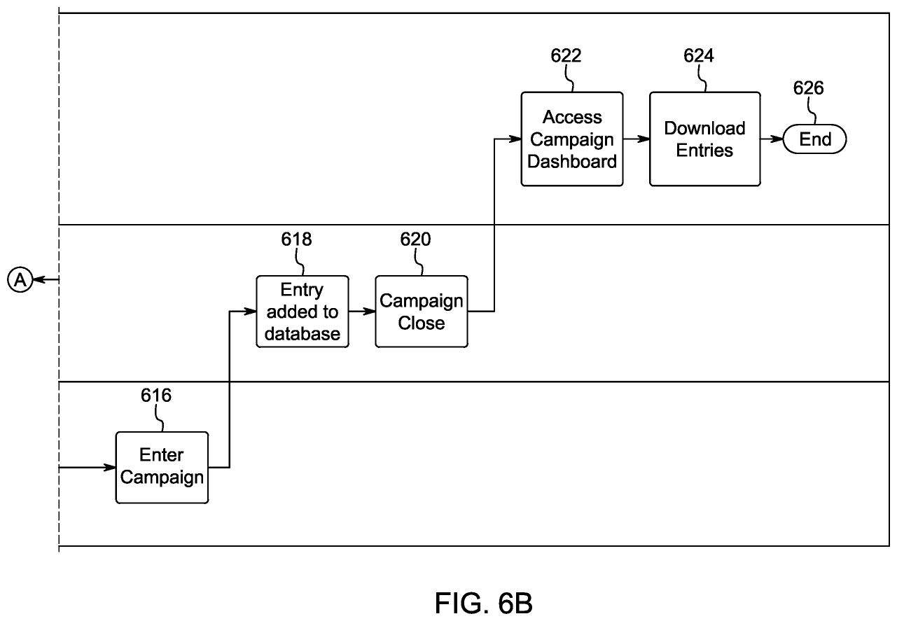

FIGS. 6A-6B illustrate a process flow 600 for creating campaigns, according to embodiments of the present invention. A campaign may include an event, a promotion, and the like associated with the smart wearable. The campaign may invite one or more users to participate in the campaign. As described above, the system may send a push notification regarding the campaign associated with the smart wearable to a user account and capture an interaction of the user with the push notification as fan engagement data associated with the user account. Further, the system may define a response time window associated with the campaign such that the response time window defines a time period when the interaction with the push notification is accepted by the club portal 112. The system may also be configured to send the push notification to one or more user accounts based on a geolocation data associated with the one or more user accounts. The campaign creation process flow 600 is discussed in detail below with reference to FIGS. 6A-6B.

The process flow 600 starts at step 602. At step 604, an admin may click create a campaign. At step 606, the admin may add a name for the campaign. The admin may further set parameters like campaign ask, campaign duration, data payload, etc. Further, at step 608, the admin may define campaign entrance criteria. The campaign entrance criteria may include participation limit, location criteria, a specific smart wearable or merchandise, etc. At step 610, the system may publish the campaign on the club portal 112. Once the admin verifies campaign data, the campaign goes live at step 612. At step 614, the system may send push notifications associated with the campaign to the users or club members. A fan in a specific geolocation may receive a campaign if the club portal 112 is set up to do so. At step 616, the user or the club member may enter the campaign within a specific time frame, if defined by the club portal 112. Step 618 adds an entry into the campaign and the database 110 is updated. At step 620, the campaign is closed. Once the campaign is closed, the admin may access the campaign dashboard at step 622 and download entries at step 624 for further analysis. The process flow 600 ends at step 626.

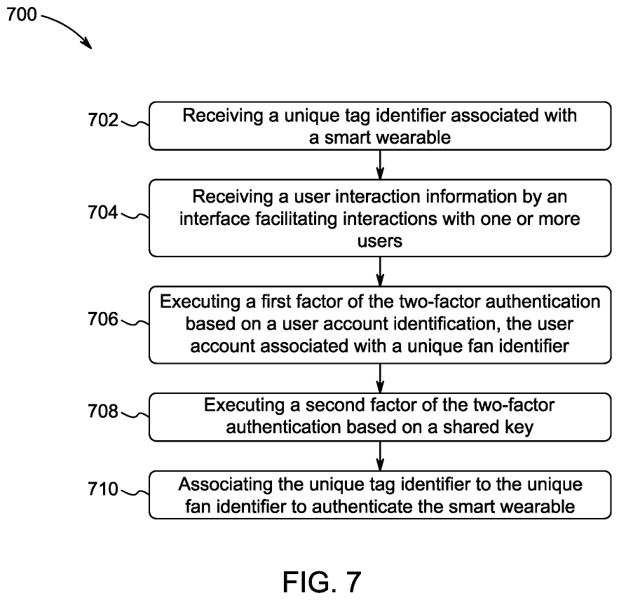

FIG. 7 illustrates a sequential flow diagram 700 for managing smart wearables.

As shown in FIG. 7, the method 700 includes receiving a unique tag identifier associated with a smart wearable, at step 702. As described above, the club portal 112 and/or associated system may receive a unique tag identifier associated with the smart wearable, such as, by scanning, by a user device, an NFC tag embedded in the smart wearable. At step 704, the method includes receiving a user interaction information by an interface or the club portal 112 facilitating interactions with one or more users. The user interaction information may include taps by a user, campaign responses, identification tag scan, and so on. At step 706, the method includes executing a first factor of the two-factor authentication based on a user account identification, wherein the user account is associated with a unique fan identifier. As described above, the club portal 112 may execute a two-factor authentication of the smart wearable, such as, as a first-factor authentication, a username and password of the user account may be verified. At step 708, the method includes executing a second factor of the two-factor authentication based on a shared key, wherein the shared key is defined by the interface using an Application Processing Interface (API) payload based on the unique tag identifier. Lastly, at step 710, on completing the two-factor authentication, the method may include associating the unique tag identifier to the unique fan identifier to authenticate the smart wearable. The association at step 710 may define an ownership of the smart wearable. In some embodiments, the ownership may be updated or re-validated at each user interaction with the club portal 112. Further, the interactions of the one or more users with the club portal 112 may be tracked and analyzed to generate fan engagement data for associated smart wearables.

In an embodiment, one or more computer-readable storage media may be utilized in implementing embodiments consistent with the present disclosure. A computer-readable storage medium refers to any physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and other known physical storage media.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the disclosure.

The disclosure has been described with reference to various specific and preferred embodiments and techniques. However, it should be understood that many variations and modifications may be made while remaining within the spirit and scope of the disclosure. It will be apparent to one of ordinary skill in the art that methods, devices, device elements, materials, procedures, and techniques other than those specifically described herein can be applied to the disclosure practice as broadly disclosed herein without resort to undue experimentation. All art-known functional equivalents of methods, devices, device elements, materials, procedures, and techniques described herein are intended to be encompassed by this disclosure. All subranges and individual values are intended to be encompassed whenever a range is disclosed. This disclosure is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the disclosure has been described with respect to a limited number of embodiments, those skilled in the art, having benefit of this disclosure, will appreciate that other embodiments can be devised which do not depart from the scope of the disclosure as disclosed herein.

I/We claim:

1. A system comprising:
a smart wearable having a unique tag identifier;
an interface receiving a user interaction information, the interface facilitates interactions with one or more users, wherein the interface is configured to execute a two-factor authentication comprising:
a user account identification, as a first factor of the two-factor authentication, wherein the user account is associated with a unique fan identifier; and
a shared key identification, as a second factor of the two-factor authentication, wherein the shared key is defined by the interface using an Application Processing Interface (API) payload based on the unique tag identifier,
wherein the interface is configured to associate the unique tag identifier to the unique fan identifier to authenticate the smart wearable.

2. The system of claim 1, further comprising an identification tag associated with the unique tag identifier, wherein the identification tag is defined by the interface using the API payload.

3. The system of claim 2, wherein the identification tag is embedded in the smart wearable.

4. The system of claim 1, further comprising an authentication module configured to at least one of update or re-validate an ownership of the smart wearable at each interaction of the user with the interface.

5. The system of claim 4, wherein the authentication module is further configured to:
update the ownership of the smart wearable from a first user with a first unique fan identifier to a second user with a second unique fan identifier based on the API payload corresponding to an interaction of the second user with the interface.

6. The system of claim 1, further comprising an engagement module configured to:
send a push notification regarding a campaign associated with the smart wearable to the user account; and
capture an interaction of the user with the push notification as fan engagement data associated with the user account.

7. The system of claim 6, wherein the engagement module defines a response time window associated with the campaign such that the response time window defines a time period when the interaction with the push notification is accepted by the interface.

8. The system of claim 6, wherein the engagement module is configured to send the push notification to one or more user accounts based on a geolocation data associated with the one or more user accounts.

9. The system of claim 1, further comprising a headless analytics and activation platform configured to analyze interactions of the one or more users with the interface to generate fan engagement data for associated smart wearables.

10. A method comprising:
receiving a unique tag identifier associated with a smart wearable; and
receiving a user interaction information by an interface facilitating interactions with one or more users, wherein the interface is configured to execute a two-factor authentication comprising:
executing a first factor of the two-factor authentication based on a user account identification, wherein the user account is associated with a unique fan identifier;
executing a second factor of the two-factor authentication based on a shared key, wherein the shared key is defined by the interface using an Application Processing Interface (API) payload based on the unique tag identifier; and
associating the unique tag identifier to the unique fan identifier to authenticate the smart wearable.

11. The method of claim 10, further comprising receiving the unique tag identifier associated with an identification tag, wherein the identification tag is defined by the interface using the API payload.

12. The method of claim 11, wherein the identification tag is embedded in the smart wearable.

13. The method of claim 10, further comprising updating or re-validating an ownership of the smart wearable at each interaction of the user with the interface.

14. The method of claim 13, further comprising updating the ownership of the smart wearable from a first user with a first unique fan identifier to a second user with a second unique fan identifier based on the API payload corresponding to an interaction of the second user with the interface.

15. The method of claim 10, further comprising:
sending a push notification regarding a campaign associated with the smart wearable to the user account; and
capturing an interaction of the user with the push notification as fan engagement data associated with the user account.

16. The method of claim 15, further comprising defining a response time window associated with the campaign such that the response time window defines a time period when the interaction with the push notification is accepted by the interface.

17. The method of claim 15, further comprising sending the push notification to one or more user accounts based on a geolocation data associated with the one or more user accounts.

18. The method of claim 10, further comprising analyzing interactions of the one or more users with the interface to generate fan engagement data for associated smart wearables.

19. A non-transitory computer-readable storage medium, having stored thereon a computer-executable program which, when executed by at least one processor, causes the at least one processor to:
analyze a unique tag identifier associated with a smart wearable; and
analyze a user interaction information received from an interface facilitating interactions with one or more users, wherein the interface is configured to execute a two-factor authentication comprising:
executing a first factor of the two-factor authentication based on a user account identification, wherein the user account is associated with a unique fan identifier;
executing a second factor of the two-factor authentication based on a shared key, wherein the shared key is defined by the interface using an Application Processing Interface (API) payload based on the unique tag identifier; and
associating the unique tag identifier to the unique fan identifier to authenticate the smart wearable.

20. The non-transitory computer-readable storage medium of claim 19, the computer-executable program further causes the at least one processor to:
update or re-validate an ownership of the smart wearable at each interaction of the user with the interface.
